(19) United States
(12) Patent Application Publication
(10) Pub. No.: US 2004/0157762 A1
(43) Pub. Date: Aug. 12, 2004

(54) Solid solvent-containing cleaning compositions

(76) Inventors: Melissa C. Meinke, Minneapolis, MN (US); Keith G. Lascotte, Maplewood, MN (US); Victor Fuk-Pong Man, St. Paul, MN (US); Denise M. Chandler, St. Paul, MN (US); James J. Tarara, Woodbury, MN (US)

Correspondence Address: MERCHANT & GOULD PC, P.O. BOX 2903, MINNEAPOLIS, MN, 55402-0903, US

(21) Appl. No.: 10/727,831

(22) Filed: Dec. 4, 2003

Related U.S. Application Data
(60) Provisional application No. 60/431,418, filed on Dec. 5, 2002.

(51) Int. Cl. C11D 3/00

(52) U.S. Cl. 510/302

(57) ABSTRACT

The present invention relates to a solid cleaning composition including effective amounts of solvent for removing soil, such as greasy or oily soil.

### CROSS REFERENCE TO RELATED APPLICATION

This application claims priority to U.S. Provisional Patent Application Serial No. 60/431,418, filed Dec. 5, 2002, the entire disclosure of which is incorporated herein by reference.

### FIELD OF THE INVENTION

The present invention relates to a solid cleaning composition including effective amounts of solvent for removing soil, such as greasy or oily soil.

### BACKGROUND OF THE INVENTION

Conventional solvent-based cleaning compositions for applications that employ high levels of grease cutting liquid solvents and liquid surfactants exist as liquids at room temperature. To date, solid cleaning compositions have not included sufficient amounts of liquid solvent or liquid surfactant to clean greasy soil. There remains a need for solid cleaning compositions including high, effective amounts of solvent for cleaning.

In addition, solvent can adversely affect foam levels desired for some applications. There remains a need for solid cleaning compositions that include liquid solvent and liquid surfactant and that also provide a high level of foam during use.

### SUMMARY OF THE INVENTION

The present invention relates to a solid cleaning composition including effective amounts of solvent for removing soil, such as greasy or oily soil.

In an embodiment, the present invention relates to a solid solvent cleaning composition, which includes solvent, solidification agent, and cleaning agent and that is a solid at room temperature. The level of solvent can be effective for removing greasy or oily soil, particularly in conjunction with the cleaning agent. The level of solvent can be higher than that achieved in conventional solid cleaning compositions. The solvent concentration in the present solid cleaning composition can be, in embodiments, at least about 10, about 15, or even about 20 wt-%. In an embodiment, the solvent includes a glycol ether. In an embodiment, the solidification agent includes a polyethylene glycol. In certain embodiments, the cleaning agent includes surfactant, alkalinity source, sequestrant, or mixtures thereof.

In an embodiment, the present solid cleaning composition includes a complex formed from a salt or other hydratable component and the cleaning agent, solidification agent, and/or solvent. In an embodiment, the amounts and/or relative amounts of solvent, solidification agent, and cleaning agent are effective to provide a solid cleaning composition with a melting point greater than 30° C., or even greater than 50° C.

### DETAILED DESCRIPTION OF THE INVENTION

Definitions

As used herein, a solid cleaning composition refers to a cleaning composition in the form of a solid such as a powder, a flake, a granule, a pellet, a tablet, a lozenge, a puck, a briquette, a brick, a solid block, a unit dose, or another known solid form of a cleaning composition.

Amounts of ingredients stated in this patent application generally refer to the amount of the particular active ingredient (e.g., nonionic surfactant). Amounts stated for commercial products typically relate to the amount of the commercial product. The amount of active provided by the commercial product can be determined from the concentration of the commercial product and the fraction of the commercial product that is the active ingredient.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use compositions in the real world; through inadvertent error in these procedures; through differences in the manufacture, source, or purity of the ingredients employed to make the compositions or carry out the methods; and the like. Whether or not modified by the term “about”, it is intended that the claims include equivalents to the quantities.

As used herein, the phrase “consisting essentially of” refers to a solid solvent-containing cleaning composition that is a solid at room temperature when containing the listed ingredients in the stated amounts, but that can also include one of more of the additives described herein.

Solid Solvent Cleaning Composition

The present invention relates to a solid cleaning composition including a substantial proportion of solvent. Typically, the solvent, when neat, is liquid at room temperature. Even with a substantial proportion of solvent that is liquid at room temperature, the present solid cleaning compositions can remain solid even at temperatures well in excess of room temperature. For example, in certain embodiments, the present solid cleaning composition can remain solid for more than a day, e.g., up to about 10 days or more, at temperatures of 30, 40, or 50° C., for advantageous storage stability. In an embodiment, the present solid cleaning composition can remain solid for more than a day (e.g., up to 10 days or more) at temperatures of 50° C.

The present solid cleaning compositions can provide a high solvent level in a high foaming cleaning composition. For example, for advantageous performance on greasy soils and in other applications benefiting from high foaming, the present solid compositions can include 30 wt-% surfactant (e.g., liquid surfactant) and 20 wt-% solvent (e.g., liquid solvent). Surprisingly, even though many surfactants and most solvents are liquid at room temperature, the present formulations can remain solid at temperatures of 30, 40, or 50° C. or at a temperature of 50° C. In fact, in an embodiment, the present solid cleaning composition can include liquid surfactant and liquid solvent and remain solid at temperatures of 30, 40, or 50° C. or at a temperature of 50° C. The amounts and proportions of surfactant and solvent can provide advantageous wetting properties that enhance cleaning.

In an embodiment, the present solid cleaning composition takes the form of a solid eutectic solution. That is, the composition is a single phase at temperatures significantly below its melting point, the composition has a single melting point. In an embodiment, the present composition takes the form of a solid dispersion, a mostly eutectic solution including suspended solute.

The present solid cleaning compositions can include solidification agent, cleaning agent, and solvent. In an embodiment, the present solid cleaning compositions include, for example, PEG 8000, surfactant, and glycol ether solvent. The inventive solid cleaning compositions can include solidification agent, cleaning agent, and solvent, for example, in the proportions and amounts described in Table 1. In certain embodiments, the proportions and amounts in Table 1 can be modified by “about”.

TABLE 1

| Component | Wt-% | Wt-% | Wt-% | Wt-% |
|---|---|---|---|---|
| Solvent | 10-25 | 15-23 | 18-22 | 20 |
| Solidification | 15-50 | 20-40 | 25-35 | 30 |
| Agent | | | | |
| Cleaning | 10-70 | 20-60 | 40-55 | 50 |
| Agent | | | | |
| Additional | 0-20 | 0.1-10 | 0.2-5 | <0.5 |
| Ingredients | | | | |

Solvent

The solvent can impart advantageous grease cutting and cleaning during use of the present solid cleaning compositions. The solvent can also provide, in cooperation with the cleaning agent and the solidification agent, a cleaning composition that remains solid, for example, for several days (up to 10, or more) at, 30, 40, or 50° C. or at 50° C. for storage and shipping stability. Solvents useful in the present solid compositions include those that are thin liquids at ambient and elevated temperatures. Therefore, high levels of such solvents were not generally considered as components of solid cleaning compositions. It was considered impractical to keep such solvents in a solid at room temperature, let alone at the high temperatures that can be encountered during storage and shipping.

Although not limiting to the present invention, it is believed that solvents that are liquids at room temperature can be fixed in the solid cleaning composition, for example, as complexes with salts. Such a complex can be envisioned as similar to hydration of a salt; a hydroxyl group (or other functional group with a free electron pair) on the solvent may complex a salt like a water of hydration interacts with a salt. In an embodiment, the present solid cleaning compositions include a complex of a salt and a solvent. Such a complex can also include water. Although not limiting to the present invention, it is believed that such a complex can impart advantageous stability for the present composition at elevated temperatures during storage and shipping. For complex formation, suitable solvents include those with hydroxyl groups, ether linkages, or other functional groups that can form similarly strong hydrogen bonds.

Advantageously, the solvent has a flash point higher than the temperatures employed for processing the present solid cleaning composition (e.g., greater than 60, 80, or 90° C.). In an embodiment, the solvent or solvents are water miscible, have a flash point higher than 80° C., and remove soils encountered in hard surface cleaning, such as milk curd, calcium deposits, beverage residues, or prepared food residues (e.g., tomato sauce, pasta, lard, mayonnaise, potato salad, and the like).

Suitable solvents include glycol ethers. Some glycol ethers are also known as cellosolves. In an embodiment, the solvent includes or is a glycol ether. Suitable glycol ethers include ethylene glycol ethers and propylene glycol ethers, for example, ethylene glycol ethers, diethylene glycol ethers, propylene glycol ethers, dipropylene glycol ethers, and the like. Suitable ethers include, for example, methyl ethers, ethyl ethers, propyl (n- or i-) ethers, and butyl (n-, i-, or t-) ethers. For example, glycol ether solvents include ethylene glycol methyl ether, ethylene glycol ethyl ether, ethylene glycol propyl ether, ethylene glycol butyl ether, diethylene glycol methyl ether, diethylene glycol ethyl ether, diethylene glycol propyl ether, diethylene glycol butyl ether, propylene glycol methyl ether, propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether, mixtures thereof, and the like.

In certain embodiments, the ethylene glycol ether includes ethylene glycol monoethyl ether, ethylene glycol monobutyl ether, diethylene glycol monomethyl ether, diethylene glycol monoethyl ether, diethylene glycol monobutyl ether, mixtures thereof, and the like. In certain embodiments, the propylene glycol ether includes propylene glycol monoethyl ether, propylene glycol monobutyl ether, dipropylene glycol monomethyl ether, dipropylene glycol monoethyl ether, dipropylene glycol monobutyl ether, mixtures thereof, and the like.

In certain embodiments the solvent includes ethylene glycol monoethyl ether, ethylene glycol monobutyl ether, propylene glycol monomethyl ether, diethylene glycol monomethyl ether, dipropylene glycol methyl ether, dipropylene glycol monopropyl ether, mixtures thereof, and the like. In certain embodiments, the glycol ether includes diethylene glycol monomethyl ether, dipropylene glycol methyl ether, dipropylene glycol normal propyl ether, mixtures thereof, and the like.

In certain embodiments, the present solid cleaning composition includes about 10 to about 30 wt-%, about 15 to about 25 wt-%, or about 18 to about 22 wt-% solvent. In an embodiment, the solvent is present at about 20 wt-%. In certain embodiments, the present solid cleaning composition includes two or three solvents, each present at about 10 to about 30 wt-%, about 2 to about 20 wt-%, or about 5 to about 10 wt-% solvent. In an embodiment, each of the two or three solvents is present at about 6 wt-%, at about 7 wt-%, or at about 10 wt-%. The composition can include any of these ranges or amounts not modified by about.

Solidification Agent

The solidification agent in the present cleaning compositions participates in maintaining the compositions in a solid form. Although other components of the solid composition may also be solids, the solidification agent can maintain the overall composition including solid and liquid (e.g., solvent and/or surfactant) components in a solid form. The solidification agent can provide other advantageous features to the compositions. For example, the solidification agent can improve level or stability of foaming by cleaning agents such as surfactants.

Suitable solidification agents include a solid polyethylene glycol (PEG), a solid EO/PO block copolymer, and the like; an amide, such as stearic monoethanolamide, lauric diethanolamide, an alkylamide, or the like; starches that have been made water-soluble through an acid or alkaline treatment process; celluloses that have been made water-soluble; various inorganics that impart solidifying properties to a heated composition upon cooling; poly(maleic anhydride/methyl vinyl ether); polymethacrylic acid; other generally functional or inert materials with high melting points; and the like.

In certain embodiments, the solidification agent includes solid PEG, for example PEG 1500 up to PEG 20,000. In certain embodiments, the PEG includes PEG 1450, PEG 3350, PEG 4500, PEG 8000, PEG 20,000, and the like. Additional suitable solidification agents include EO/PO block copolymers such as those sold under the tradenames Pluronic 108, Pluronic F68; amides such as lauric diethanolamide or cocodiethylene amide; and the like. In certain embodiments, the solidification agent includes a combination of solidification agents, such as combination of PEG and an EO/PO block copolymer (such as a Pluronic) and combination of PEG and an amide (such as lauric diethanol amide or stearic monoethanol amide).

In an embodiment, for more controlled dispensing, the solidification agent is not an extremely water soluble solid, such as urea. In this embodiment, other disfavored solidification agents include other hygroscopic solids.

In certain embodiments, the present solid composition includes solidification agent at about 10 to about 55 wt-%, about 15 to about 50 wt-%, about 15 to about 45 wt-%, about 15 to about 40 wt-%, about 15 to about 35 wt-%, about 20 to about 40 wt-%, about 20 to about 35 wt-%, about 20 to about 30 (e.g., 32) wt-%, about 24 to about 30 wt-%, or about 25 to about 35 wt-%. In certain embodiments, the present solid composition includes solidification agent at about 18 wt-%, about 24 wt-%, about 26 wt-%, about 28 wt-%, or about 30 wt-%. The composition can include any of these ranges or amounts not modified by about.

In certain embodiments, when the solidification agent is a solid PEG (e.g., PEG 8000), the present solid composition can include solid PEG at about 15 to about 40 wt-%, about 15 to about 35 wt-%, about 20 to about 30 (e.g., 32) wt-%, or about 24 to about 30 wt-%. In certain embodiments, the present solid composition includes solid PEG at about 18 wt-%, about 24 wt-%, about 26 wt-%, or about 28 wt-%. In an embodiment, the neat solvent is a liquid at room temperature. The composition can include any of these ranges or amounts not modified by about.

Secondary Solidification Agent

The present compositions can include a minor but effective amount of a secondary solidification agent. The secondary solidification agent can assist the solidification agent in maintaining the solid cleaning composition in solid form. For example, the secondary solidification agent can tie up liquid solvent or water in the composition. Suitable secondary solidification agents include an inorganic agent, such as, sodium acetate, sodium sulfate, sodium carbonate, alkali metal phosphates (e.g., STPP, TKPP, and TSPP), silicates, such as sodium silicate and sodium metasilicate, mixtures thereof, or the like.

In certain embodiments, the secondary solidification agent includes an alkali or neutral metal salt, such as sodium acetate, sodium sulfate, STPP, TSPP, TKPP, sodium metasilicate, sodium hydroxide, mixture thereof, or the like. In certain embodiments, the secondary solidification agent includes sodium acetate, sodium sulfate, TSPP, sodium metasilicate, sodium hydroxide, mixture thereof, or the like. In certain embodiments, the secondary solidification agent includes sodium acetate, sodium sulfate, or a mixture thereof.

In certain embodiments, the present solid composition includes secondary solidification agent at about 0 to about 5 wt-%, about 0.5 to about 4 wt-%, or about 1 to about 3 wt-%. In an embodiment, the present solid composition includes secondary solidification agent at about 2 wt-%. The composition can include any of these ranges or amounts not modified by about.

Cleaning Agent

The present solid cleaning composition includes a cleaning agent that can remove soils from an article or surface. The cleaning agent can work in conjunction with the solidification agent and/or the solvent. Any of a variety of cleaning agents can be employed in the present compositions. For example, the composition can include as cleaning agent surfactant, sequestrant, alkalinity source, combination thereof, or the like. In certain embodiments, the cleaning agent includes surfactant, sequestrant, alkalinity source, or mixtures thereof.

In certain embodiments, the present solid composition includes cleaning agent at about 10 to about 70 wt-%, about 20 to about 60 wt-%, or about 40 to about 55 wt-%. In an embodiment, the present solid composition includes cleaning agent at about 50 wt-%. The composition can include any of these ranges or amounts not modified by about. The cleaning composition can include a cleaning agent in an amount effective to provide a desired level of cleaning.

Surfactant

The cleaning agent can be a surfactant or surfactant system. A variety of surfactants can be used in the present solid cleaning composition, including anionic, nonionic, cationic, and zwitterionic surfactants, which are commercially available. In certain embodiments, the surfactants include nonionic surfactants, anionic surfactants, or mixtures thereof. For a discussion of surfactants, see Kirk-Othmer, Encyclopedia of Chemical Technology, Third Edition, volume 8, pages 900-912.

In certain embodiments, the present solid composition includes surfactant at about 0.1 to about 60 wt-%, about 1 to about 30 wt-%, about 1 to about 40 wt-%, about 10 to about 50 wt-%, or about 20 to about 40 wt-%. In an embodiment, the present solid composition includes surfactant at about 30 wt-%. In an embodiment, the surfactant itself is a liquid at room temperature. The composition can include any of these ranges or amounts not modified by about. The cleaning composition can include surfactant in an amount effective to provide a desired level of cleaning.

Nonionic surfactants useful in the present solid cleaning compositions, include those having a polyalkylene oxide polymer as a portion of the surfactant molecule. These surfactants can be capped or uncapped. Such nonionic surfactants include, for example, chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, fatty alcohol ethoxylates (e.g., tridecyl alcohol alkoxylate, ethylene oxide adduct), and the like; nonylphenol ethoxylate, polyoxyethylene glycol ethers, and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC (BASF-Wyandotte), and the like; ethoxylated amines and ether amines commercially available from Tomah Corporation and other like nonionic compounds. Silicone surfactants such as the ABIL B8852 (Goldschmidt) can also be used.

In certain embodiments, the nonionic surfactant includes alkyl phenol ethoxylate, linear and secondary alcohol ethoxylate (fatty alcohol ethoxylate, e.g., tridecyl alcohol alkoxylate, ethylene oxide adduct), ethoxy/propoxy block surfactant, polyether siloxane, or mixture thereof. Examples of suitable nonionic surfactants include EO/PO block nonionic surfactant terminated in PO, silicone nonionic surfactant, benzyl ether of a polyethoxylated primary alcohol, nonylphenol ethoxylate (e.g., nonylphenol 9.5 mole ethoxylate), and the like.

In certain embodiments, the nonionic surfactant is present at about 1 to about 30 wt-%, about 5 to about 20 wt-%, or about 10 to about 15 wt-%. In an embodiment, the nonionic surfactant is present at about 15 (e.g., 14) wt-%. The composition can include any of these ranges or amounts not modified by about.

Anionic surfactants useful in the present solid cleaning compositions, include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates (e.g, linear dodecyl benzene sulfonic acid or salts thereof), alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, ethoxylated alcohol phosphate esters, and the like. In certain embodiments, the anionic surfactant includes sodium alkylarylsulfonate, alkylbenzenesulfonate (e.g, linear dodecyl benzene sulfonic acid or salts thereof), ethoxylated alcohol phosphate ester, alpha-olefin sulfonate, fatty alcohol sulfate, or mixture thereof.

In certain embodiments, the anionic surfactant is present at about 1 to about 40 wt-%, about 1 to about 20 wt-%, about 3 to about 15 wt-%, about 5 to about 30 wt-%, about 5 to about 10 wt-%, or about 5 to about 10 wt-%, or about 10 to about 20 wt-%. In certain embodiments, the anionic surfactant is present at about 8 wt-% or about 16 wt-%. The composition can include any of these ranges or amounts not modified by about.

Although not limiting to the present invention, it is believed that surfactant, particularly surfactant that is a liquid at room temperature, can be fixed in the solid cleaning composition, for example, as a complex with one or more salts. Such a complex can be envisioned as similar to hydration of a salt; a hydroxyl group (or other functional group with a free electron pair) on the surfactant may complex a salt like a water of hydration. In an embodiment, the present solid cleaning compositions include a complex of a salt and a surfactant. Although not limiting to the present invention, it is believed that such a complex can impart advantageous stability for the present composition at elevated temperatures during storage and shipping.

Sequestrant/Builder

The cleaning agent can be or include a sequestrant or builder. In general, a sequestrant is a molecule capable of coordinating (i.e., binding) the metal ions commonly found in natural water to prevent the metal ions from interfering with the action of the other detersive ingredients of a cleaning composition. Some chelating/sequestering agents can also function as a threshold agent when included in an effective amount. For a further discussion of chelating agents/sequestrants, see Kirk-Othmer, Encyclopedia of Chemical Technology, Third Edition, volume 5, pages 339-366 and volume 23, pages 319-320.

A variety of sequestrants or builders can be used in the present solid cleaning composition, including, for example, organic phosphonate, aminocarboxylate, condensed phosphate, polyphosphate, inorganic builder, polymeric polycarboxylate, mixture thereof, or the like. Such sequestrants and builders are commercially available. In certain embodiments, the present solid cleaning composition includes about 0.1 to about 30 wt-%, about 0.2 to about 25 wt-%, about 0.2 to about 10 wt-%, about 0.5 to about 25 wt-%, about 0.5 to about 2 wt-%, about 5 to about 20 wt-%, or about 10 to about 15 wt-% sequestrant or builder. The composition can include any of these ranges or amounts not modified by about.

Suitable organic phosphonates include organic-phosphonic acids, and alkali metal salts thereof. Some examples of suitable organic phosphonates include:

1-hydroxyethane-1,1-diphosphonic acid: CH₃C(OH)[PO(OH)₂]₂;

aminotri(methylenephosphonic acid): N[CH₂PO(OH)₂]₃;

aminotri(methylenephosphonate), sodium salt

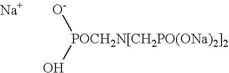

2-hydroxyethyliminobis(methylenephosphonic acid): HOCH₂CH₂N[CH₂PO(OH)₂]₂;

diethylenetriaminepenta(methylenephosphonic acid): (HO)₂POCH₂N[CH₂CH₂N[CH₂PO(OH)₂]₂]₂;

2-phosphonobutane-1,2,4-tricarboxylic acid;

diethylenetriaminepenta(methylenephosphonate), sodium salt: C₉H₍₂₈₋ₓ₎N₃NaₓO₁₅P₅ (x=7);

hexamethylenediamine(tetramethylenephosphonate), potassium salt: C₁₀H₍₂₈₋ₓ₎N₂KₓO₁₂P₄ (x=6);

bis(hexamethylene)triamine(pentamethylenephosphonic acid): (HO₂)POCH₂N[(CH₂)₆N[CH₂PO(OH)₂]₂]₂; and

phosphorus acid H₃PO₃; and other similar organic phosphonates, and mixtures thereof.

The sequestrant can be or include aminocarboxylic acid type sequestrant. Suitable aminocarboxylic acid type sequestrants include the acids or alkali metal salts thereof, e.g., amino acetates and salts thereof. Some examples include the following:

N-hydroxyethylaminodiacetic acid;

hydroxyethylenediaminetetraacetic acid, nitrilotriacetic acid (NTA);

ethylenediaminetetraacetic acid (EDTA);

N-hydroxyethyl-ethylenediaminetriacetic acid (HEDTA);

diethylenetriaminepentaacetic acid (DTPA); and

alanine-N,N-diacetic acid;

and the like; salts thereof, and mixtures thereof.

In certain embodiments, the aminocarboxylate includes ethylenediamine tetraacetic acid (EDTA), diethylenetriamine pentaacetic acid (DTPA), their alkali metal salts, or mixtures thereof. In an embodiment, the aminocarboxylate includes the sodium salt of EDTA.

In certain embodiments, the aminocarboxylate is present at about 0.1 to about 30 wt-%, about 0.2 to about 10 wt-%, or about 0.5 to about 2 wt-%. In an embodiment, the aminocarboxylate is present at about 1 wt-%. The composition can include any of these ranges or amounts not modified by about.

Examples of condensed and/or polyphosphates include sodium and potassium orthophosphate, sodium and potassium pyrophosphate, sodium and potassium tripolyphosphate, sodium hexametaphosphate, and the like, e.g., the sodium salt, e.g., of pyrophosphate. A condensed phosphate may also assist, to a limited extent, in solidification of the composition by fixing the free water present in the composition as water of hydration. In an embodiment, the present solid cleaning composition includes as a builder, chelator, or sequestrant a condensed phosphate, such as tetrasodium pyrophosphate.

In certain embodiments, the present solid cleaning composition includes about 0.1 to about 30 wt-%, about 5 to about 20 wt-%, or about 10 to about 15 wt-% condensed and/or polyphosphate. In an embodiment, the condensed and/or polyphosphate is present at about 13 wt-%. The composition can include any of these ranges or amounts not modified by about.

Polycarboxylates suitable for use as cleaning agents include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In an embodiment, the present solid cleaning composition includes as sequestrant or builder condensed phosphate and aminocarboxylate, for example, tetrasodium pyrophosphate and EDTA. In an embodiment, the sodium salt of condensed phosphate is preferred to the corresponding potassium salt.

Alkalinity Source

The present solid cleaning composition can include effective amounts of one or more alkalinity sources to enhance cleaning of a substrate and improve soil removal performance of the composition. The source of alkalinity can include an alkali metal salt, such as alkali metal carbonate, alkali metal hydroxide, alkali metal silicate (e.g., metasilicate), or the like; metal borate, such as sodium or potassium borate, and the like; ethanolamines and amines; inorganic alkalinity source, such as alkali metal hydroxide or silicate (e.g., metasilicate), or the like; and other like alkaline sources. The choice and the quantity of alkalinity source can be sufficient to render the composition mildly alkaline.

Suitable alkali metal hydroxides include, for example, sodium or potassium hydroxide, e.g., sodium hydroxide. An alkali metal hydroxide may be added to the composition in a variety of forms, including for example in the form of solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50 wt-% and a 73 wt-% solution.

Examples of useful alkaline metal silicates include sodium or potassium silicate (with a M₂O:SiO₂ ratio of 1:2.4 to 5:1, M representing an alkali metal) or metasilicate. In an embodiment, the alkaline metal silicate includes sodium metasilicate.

In certain embodiments, the alkaline source includes a salt of metasilicate, of silicate, or of carbonate, e.g., a sodium salt.

In certain embodiments, the present solid cleaning composition includes about 0 to about 15 wt-%, about 0.1 to about 15 wt-%, about 0.5 to about 10 wt-%, about 1 to about 10 wt-%, about 1 to about 4 wt-%, about 2 to about 10 wt-%, about 2 to about 4 wt-%, about 3 to about 7 wt-%, or about 5 to about 9 wt-% source of alkalinity. In certain embodiments, the source of alkalinity is present at about 2 wt-%, at about 3 wt-%, at about 5 wt-%, or about 7 wt-%. The composition can include any of these ranges or amounts not modified by about.

Constituent Concentrations

Some examples of representative constituent concentrations for the present solid cleaning compositions can be found in Table 2, in which the values are given in wt-% of the ingredients in reference to the total composition weight. In certain embodiments, the proportions and amounts in Table 2 can be modified by “about”.

TABLE 2

| | | Wt-% | Wt-% | Wt-% | Wt-% |
|---|---|---|---|---|---|
| Solvent | | 10-30 | 15-25 | 18-22 | 20 |
| Solidification | Primary | 10-50 | 15-40 | 20-30 | 28 |
| Agent | | | | | |
| | Secondary | 0-5 | 0.5-4 | 1-3 | 2 |
| Cleaning | Surfactant | 0.1-60 | 10-50 | 20-40 | 30 |
| Agent | | | | | |
| | Alkalinity | 0-15 | 1-10 | 3-7 | 5 |
| | Source | | | | |
| | Sequestrant or | 0.1-30 | 5-20 | 10-15 | 13 |
| | Builder | | | | |
| Additional | | 0-3 | 0.1-1 | 0.2-0.4 | 2 |
| Ingredients | | | | | |

Embodiments of concentrations of representative constituents for the present solid cleaning compositions can be found in Table 3, in which the values are given in wt-% of the ingredients in reference to the total composition weight. In certain embodiments, the proportions and amounts in Table 3 can be modified by “about”.

TABLE 3

| | | Wt-% | Wt-% | Wt-% | Wt-% |
|---|---|---|---|---|---|
| Solvent | Glycol Ether 1 | 1-30 | 2-20 | 5-10 | 7 |
| | Glycol Ether 2 | 1-30 | 2-20 | 5-10 | 7 |
| | Glycol Ether 3 | 0-30 | 2-20 | 5-10 | 7 |
| Primary | High Molecular Weight | 10-50 | 15-40 | 20-30 | 28 |
| Solidifying Agent | Polyethylene Glycol | | | | |
| | (e.g., PEG 8000, PEG | | | | |
| | 10,000) | | | | |
| Secondary | Inorganic Solidifying | 0-5 | 0.5-4 | 1-3 | 2 |
| Solidifying Agent | Agent | | | | |
| Surfactant | Nonionic | 1-30 | 5-20 | 10-15 | 14 |
| | Sulfonic | 1-20 | 3-15 | 5-10 | 8 |
| | Acid Ester | | | | |
| | Phosphate | 1-20 | 3-15 | 5-10 | 8 |
| | Ester | | | | |
| Alkalinity Source | Alkali Metal | 0.1-15 | 0.5-10 | 1-4 | 2 |
| | Hydroxide | | | | |
| | Other (e.g., | 0-15 | 1-10 | 2-4 | 3 |
| | silicate salt) | | | | |
| Sequestrant or | Aminocarboxylate | 0.1-30 | 0.2-10 | 0.5-2 | 1 |
| Builder | | | | | |
| | Condensed Phosphate | 0.1-30 | 5-20 | 10-15 | 12 |

Additives

Solid cleaning compositions according to the invention can also include additional functional materials or additives that provide a beneficial property, for example, to the composition in solid form or when dispersed or dissolved in an aqueous solution, e.g., for a particular use. Examples of conventional additives include one or more of each detersive polymer, rinse aid composition, softener, pH modifier, source of acidity, anti-corrosion agent, solubility modifier, detergent filler, anti-redeposition agent, antimicrobial, rinse aid composition, threshold agent or system, aesthetic enhancing agent (i.e., dye, odorant, perfume), optical brightener, lubricant composition, bleaching agent, enzyme, effervescent agent, other such additives or functional ingredients, and the like, and mixtures thereof.

Adjuvants and other additive ingredients will vary according to the type of composition being manufactured, and the intended end use of the composition. In certain embodiments, the composition includes as an additive one or more of cleaning enzyme, dye, antimicrobial, or mixtures thereof.

Antimicrobials

Antimicrobial agents are chemical compositions that can be used in a solid cleaning compositions that alone, or in combination with other components, act to reduce or prevent microbial contamination and deterioration of commercial products material systems, surfaces, etc. In some aspects, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, virus, yeast, spores, and fungus microorganisms. In use, the antimicrobial agents can be formed into a solid functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s-triazine, dithiocarbamates such as sodium dimethyldithiocarbamate, and a variety of other materials are known in the art for their antimicrobial properties. In some embodiments, an antimicrobial component can be included in the range of 0.001 to 75% by wt. of the composition, e.g., 0.01 to 20 wt-% of the composition, e.g., 0.05 to 10 wt-% of the composition.

Detergent Fillers

A cleaning composition may include an effective amount of one or more of a detergent filler which does not perform as a cleaning agent per se, but cooperates with the cleaning agent to enhance the overall processability of the composition. Examples of fillers suitable for use in the present cleaning compositions include sodium sulfate, sodium chloride, starch, sugars, C₁-C₁₀ alkylene glycols such as propylene glycol, and the like. A filler such as a sugar (e.g. sucrose) can aid dissolution of a solid composition by acting as a disintegrant. In certain embodiments, detergent filler is included in an amount of about 1-20 wt-%, e.g., about 3-15 wt-%.

Anti-Redeposition Agents

A cleaning composition can also include an anti-redeposition agent capable of facilitating sustained suspension of soils in a cleaning solution and preventing the removed soils from being redeposited onto the substrate being cleaned. Examples of suitable anti-redeposition agents include fatty acid amides, fluorocarbon surfactants, complex phosphate esters, styrene maleic anhydride copolymers, and cellulosic derivatives such as hydroxyethyl cellulose, hydroxypropyl cellulose, and the like. A cleaning composition can include about 0.5-10 wt-%, e.g., about 1-5 wt-%, of an anti-redeposition agent.

Dyes/Odorants

Various dyes, odorants including perfumes, and other aesthetic enhancing agents may also be included in the composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), Pylaklor Pink LX-10613, and the like.

Fragrances or perfumes that may be included in the compositions include, for example, terpenoids such as citronellol, aldehydes such as amyl cinnamaldehyde, ajasmine such as C1S-jasmine orjasmal, vanillin, and the like.

Aqueous Medium

The ingredients may optionally be processed in a minor but effective amount of an aqueous medium such as water to achieve a mixture, to aid in the solidification, to provide an effective level of viscosity for processing the mixture, and to provide the processed composition with the desired amount of firmness and cohesion during discharge and upon hardening. In an embodiment, the water serves as a processing medium and also forms part of the binding agent, as described hereinabove. The mixture during processing can include aqueous medium at up to about 12 wt-%, at about 0.2 to about 12 wt-%, about 0.2 to about 5 wt-%, about 0.3 to about 3 wt-%, or about 0.5 to about 10 wt-%.

Concentrate and Use Compositions

The solid cleaning composition according to the present invention can be suspended or dissolved in water to form a concentrate or intermediate composition. The present cleaning composition can be dissolved in water to form a use composition. For example, a dispenser can spray the solid composition with water to form a concentrate, intermediate, or use composition. That composition can collect in a day tank. That composition can be delivered from the dispenser to the site of use. At the site of use, the concentrate or intermediate concentration can be diluted to form the use composition. Alternatively, the present solid cleaning composition can be added to or mixed with sufficient water to form a use composition without forming a concentrate composition. For example, the solid cleaning composition can be diluted directly with water to form a use composition.

In an embodiment, the present solid solvent cleaning composition can be dissolved to form a use composition that is used in a foamer. Foaming application can be accomplished, for example, using a foam application device such as a tank foamer or an aspirated wall mounted roamer, e.g., employing a roamer nozzle of a trigger sprayer. Foaming application can be accomplished by placing the use composition in a fifteen gallon foam application pressure vessel, such as a fifteen gallon capacity stainless steel pressure vessel with mix propeller. The foaming composition can then be dispensed through a foaming trigger sprayer. A wall mounted foamer can use air to expel foam from a tank or line.

The concentrate composition can include about 1 to about 20 wt-%, about 2 to about 15 wt-%, or about 5-15 wt-% of the solid cleaning composition. The use composition can include about 0.01 to about 3 wt-%, about 0.1 to about 2.5 wt-%, or about 0.3 to about 2 wt-% of the solid cleaning composition.

Processing of the Composition

Any of a variety of known methods for casting, extruding, or otherwise processing solid cleaning compositions can be employed for processing the present composition. For example, a broad variety of mixing, forming, casting, molding, extruding, and other such techniques may be used to form the solid composition in accordance with other embodiments of the invention.

In an embodiment, a suitable solid solvent cleaning composition can be formed, for example, by: (i) mixing the surfactant, source of alkalinity (if desired), and solidification agent; (ii) heating, if necessary, to form a melt; (iii) blending in the solvent and additional solid ingredients, such as builder or secondary solidification agent (if present); and (iv) cooling the composition to form a solid solvent cleaning composition. The composition can be cast into a receptacle before complete solidification. Solidification of the composition can be accomplished by any conventional manner, such as cooling under room conditions, spraying with cold water, quenching in a cooling tank, or cooling in a refrigerated unit.

In an embodiment the ingredients can be mixed and extruded. The present compositions can be extruded by, for example, mixing the ingredients or premixes in order, and dispensing the mixed composition, e.g., into a container or shrink wrap. The mixture can be discharged from the mixing system through a die or other shaping apparatus and cut to a desired length. Alternatively, the molten mixture can be extruded into a shaped container and allowed to solidify.

Mixing for extrusion can include continuous mixing of the ingredients at high shear to form a substantially homogeneous liquid or semi-solid mixture in which the ingredients are distributed throughout its mass. The mixing system can include means for mixing the ingredients to provide shear or heat effective for maintaining the mixture at a flowable consistency. The mixture can be processed at a temperature to maintain the physical and chemical stability of the ingredients. The mixture can be processed at a temperature to keep the ingredients sufficiently liquid to flow and solid enough to harden. An ingredient can be in the form of a liquid or a solid such as a dry particulate, and may be added to the mixture separately or as part of a premix with another ingredient. One or more premixes may be added to the mixture. The temperature of the mixture when discharged from the mixing system can be sufficiently low to enable the mixture to be cast or extruded directly into shape that can be cut to the desired length without first cooling the mixture.

Packaging System

In some embodiments, the solid composition can be packaged. The packaging receptacle or container may be rigid or flexible, and composed of any material suitable for containing the compositions produced according to the invention, as for example glass, metal, plastic film or sheet, cardboard, cardboard composites, paper, and the like.

In an embodiment, the temperature of the processed mixture is low enough so that the mixture may be cast, molded or extruded directly into the container or other packaging system without structurally damaging the material. As a result, a wider variety of materials may be used to manufacture the container than those used for compositions that processed and dispensed under molten conditions.

In an embodiment, the packaging used to contain the compositions includes a rigid capsule.

Dispensing of the Processed Compositions

The cleaning composition made according to the present invention can be dispensed by any suitable method generally known. In an embodiment, the present solid solvent cleaning composition is dissolved to form a use composition that is dispensed by foaming it onto the object to be cleaned. Foaming application can be accomplished by a foamer applicator. For example, a roamer can inject compressed air into a container of the dissolved composition, and apply it to the surface to be cleaned through a foam application device such as a tank foamer or an aspirated wall mounted foamer, e.g., employing a foamer nozzle of a trigger sprayer.

The cleaning composition can be dispensed from a spray-type dispenser such as that disclosed in U.S. Pat. Nos. 4,826,661, 4,690,305, 4,687,121, 4,426,362 and in U.S. Pat. Nos. Re 32,763 and 32,818, the disclosures of which are incorporated by reference herein. Briefly, a spray-type dispenser functions by impinging a water spray upon an exposed surface of the solid composition to dissolve a portion of the composition, and then directing the concentrate or use solution including the composition out of the dispenser to a storage reservoir or directly to a point of use.

In some embodiments, the compositions hereof will be formulated such that during use in aqueous cleaning operations the wash water will have a pH of between about 1 and about 14, e.g., between about 6.5 and about 11, e.g., between about 7 and about 10.5. Techniques for controlling pH at recommended usage levels include the use of buffers, alkali, acids, etc., and are well known to those skilled in the art.

Methods Employing the Present Compositions

It is contemplated that the cleaning compositions of the invention can be used in a broad variety of institutional, food industry, household, vehicle care, and other such applications. Some examples include surface cleaner, vehicle cleaning, floor cleaning, hard surface cleaning, clean in place, and a broad variety of other such applications. The present cleaning compositions can be employed for cleaning an article soiled with greasy and/or oily soil and benefiting cleaning with a neutral, mild alkaline, and/or foaming cleaning composition.

The methods include making from the solid cleaning composition a concentrate and/or use composition, and applying the use composition to the article to be cleaned. In an embodiment, the use composition is foamed onto the article to be cleaned. In these methods, the present composition provides more and/or longer lasting foam than conventional foaming hard surface cleaning compositions.

The present invention may be better understood with reference to the following examples. These examples are intended to be representative of specific embodiments of the invention, and are not intended as limiting the scope of the invention.

### EXAMPLES

### Example 1

### Solid Solvent Cleaning Compositions

Examples of the present solid cleaning composition with large amounts of solvent suitable for cleaning hard surfaces were made, and included:

TABLE 4

| Ingredient | wt-% | wt-% | wt-% |
|---|---|---|---|
| Dipropylene Glycol | 6.6 | 6.5 | 6.7 |
| Methyl Ether | | | |
| Diethylene Glycol | 6.6 | 6.5 | 6.7 |
| Monomethyl Ether | | | |
| Dipropylene Glycol | 6.5 | 6.5 | 6.6 |
| n-propyl ether | | | |
| Polyethylene | 28 | 28 | 28 |
| Glycol 8000 | | | |
| Sodium sulfate | 2 | 2 | 2 |
| NPE 9.5 | 14 | 13.5 | 14 |
| Linear Dodecyl | 8.1 | 8.1 | 8.3 |
| Benzene Sulfonic | | | |
| Acid 96% | | | |
| Ethoxylated Alcohol | 8.1 | 8.1 | 8 |
| Phosphate Ester | | | |
| Sodium Hydroxide | 4.3 | 2.1 | 2.2 |
| | 50% liquid | bead | bead |
| Sodium metasilicate, | 2.7 | 2.7 | 2.8 |
| anhydrous | | | |
| Tetrasodium | 1.1 | 1.1 | 1.1 |
| EDTA powder | | | |
| Tetrasodium | 12 | 12 | 12 |
| pyrophosphate | | | |
| Pylaklor Pink | 0.006 | 0.006 | 0.006 |
| LX-10613 | | | |
| Water, soft | 0.25 | 0.75 | 0.8 |

The composition was mixed and heated (if required) to form a semisolid composition that was cooled and cast into a container. The composition remained solid at 50° C. for up to 10 days (or more) provided long lasting foam when foamed onto a surface, and cleaned well.

### Example 2

### Water and Surfactant Stabilize the Solid Solvent Composition

In another set of experiments, water and surfactant levels in the composition above were altered, and melting and other properties were determined.

The results of these experiments are shown in Tables 5 and 6. In each study the solid composition was heated.

The results in Table 5 demonstrate that increasing the amount of surfactant (specifically NPE 9.5, which is a liquid at room temperature) in the composition increased the melting point and decreased the observed phase separation. That is, increasing the amount of surfactant stabilized the composition. This suggests that the surfactant is involved in a complex, for example, with a salt in the composition and that the complex stabilizes the composition.

The results in Table 6 demonstrate that decreasing the amount of water in the composition increased the melting point. In fact, a certain small amount of water, for example, less than about 1 wt-%, specifically about 0.75 wt-% (Example D), can result in a melting point larger than the melting point with little or no water (e.g. Example A with 0.25 wt-% water). Decreasing the amount of water, at least to a certain minimum amount, stabilizes the composition. This suggests that the composition may be stabilized by complexes of water and other components with free electron pairs with a salt in the composition.

TABLE 5
Surfactant Stabilizes the Solid Solvent Cleaning Composition.

| | 23.3% Increase | | 25% Decrease | 50% Decrease | |
|---|---|---|---|---|---|
| | in NPE 9.5 | CONTROL | in NPE 9.5 | in NPE 9.5 | No NPE 9.5 |
| Ingredient | grams | wt-% | grams | grams | grams |
| Dipropylene glycol methyl ether | 6.5 | 6.5 | 6.5 | 6.5 | 6.5 |
| Diethy. glyc. monomethyl ether | 6.5 | 6.5 | 6.5 | 6.5 | 6.5 |
| Diprop. glycol n-propyl ether | 6.5 | 6.5 | 6.5 | 6.5 | 6.5 |
| PEG 8000 | 28.0 | 28.0 | 28.0 | 28.0 | 28.0 |
| Sodium sulfate | 2.0 | 2.0 | 2.0 | 2.0 | 2.0 |
| NPE 9.5 | 16.6 | 13.5 | 10.2 | 6.7 | 0 |
| LAS 97% | 8.1 | 8.1 | 8.1 | 8.1 | 8.1 |
| Ethox. alcohol phos. ester | 8.1 | 8.1 | 8.1 | 8.1 | 8.1 |
| NaOH 50% | 4.3 | 4.3 | 4.3 | 4.3 | 4.3 |
| Na metasilicate anh. gran | 2.7 | 2.7 | 2.7 | 2.7 | 2.7 |
| EDTA granules | 1.1 | 1.1 | 1.1 | 1.1 | 1.1 |
| TSPP | 12.2 | 12.2 | 12.2 | 12.2 | 12.2 |
| Pink dye | 0.006 | 0.006 | 0.006 | 0.006 | 0.006 |
| Water, soft | 0.25 | 0.25 | 0.25 | 0.25 | 0.25 |
| Total | 103.0 | 100.0 | 97.0 | 93.0 | 86.0 |
| Results | Phase sep. | Phase sep. | Phase sep. | Phase sep. | Phase sep. |
| Appearance (Top/Bottom ratio) | 90%/10% | 77%/23% | 75%/25% | 70%/30% | 62%/38% |
| Fisher Johns Melting pt. | 120.2° F. | 118.4° F. | 117.5° F. | 115.7° F. | 114.8° F. |

TABLE 6
Low Water Increases Melting Point of the Solid Solvent Cleaning Composition

| | A | D | C | B | Control |
|---|---|---|---|---|---|
| Ingredient | grams | grams | grams | grams | grams |
| Dipropylene glycol methyl ether | 6.5 | 6.5 | 6.5 | 6.5 | 6.5 |
| Diethy. glyc. monomethyl ether | 6.5 | 6.5 | 6.5 | 6.5 | 6.5 |
| Diprop. glycol n-propyl ether | 6.5 | 6.5 | 6.5 | 6.5 | 6.5 |
| PEG 8000 | 28.0 | 28.0 | 28.0 | 28.0 | 28.0 |
| Sodium sulfate | 2.0 | 2.0 | 2.0 | 2.0 | 2.0 |
| NPE 9.5 | 13.5 | 13.5 | 13.5 | 13.5 | 13.5 |
| LAS 97% | 8.1 | 8.1 | 8.1 | 8.1 | 8.1 |
| Ethox. alcohol phos. ester | 8.1 | 8.1 | 8.1 | 8.1 | 8.1 |
| NaOH, bead | 2.1 | 2.1 | 2.1 | 2.1 | 4.3 |
| | | | | | (50% NaOH, |
| | | | | | 2.15% water here) |
| Na metasilicate anh. gran | 2.7 | 2.7 | 2.7 | 2.7 | 2.7 |
| EDTA granules | 1.1 | 1.1 | 1.1 | 1.1 | 1.1 |
| TSPP | 12.2 | 12.2 | 12.2 | 12.2 | 12.2 |
| Pink dye | 0.006 | 0.006 | 0.006 | 0.006 | 0.006 |
| Water, soft | 0.25 | 0.75 | 1.35 | 1.85 | 0.25 |
| Total | 98.0 | 98.0 | 99.0 | 99.0 | 100.0 |
| Fisher-Johns Melting pt. | 123.8° F. | 125.6° F. | 120.2° F. | 119.3° F. | 117.5° F. |
| appearance at 122° F. | uniform pink | uniform pink | uniform pink | uniform pink | separated |
| T = 10 days | soft pink paste | soft pink paste | melted paste | melted paste | Red top/gran |
| | | | | | bottom |
| | not able to pour | not able to pour | able to pour | able to pour | able to pour |

### Example 3

### The Present Solid Solvent Cleaning Composition Exhibits Superior Cleaning and Foaming

The present solid solvent cleaning composition was evaluated for cleaning and foaming, and found to be superior to a comparable liquid cleaning composition.

The results of these studies are shown in Tables 7, 8, and 9. Tables 7 and 8 show results for removal of yellow food soil and red food soil, respectively. Table 9 shows results of evaluation of foaming.

The results in Table 7 show that the present solid cleaning composition produced superior removal of yellow food soil compared to a comparable liquid cleaning composition. A piece of delrin material was soiled with a yellow food soil. Yellow food soil includes beef stew, tomato sauce, margarine, and powdered milk. The soiled delrin material was contacted with the cleaning composition for 5 minutes, and the material was dipped in a water rinse. The weight of the soil on the material was determined before and after cleaning.

TABLE 7
Superior Removal of Yellow Food Soil by the
Present Solid Solvent Cleaning Composition.

| | Amount in | | Average % |
|---|---|---|---|
| | Use Solution | % Soil | Soil |
| | (gm/gal) | Removed | Removed |
| Comparable Liquid | 99 | 28.97 | 29.19 |
| Cleaning | | 29.41 | |
| Composition | | | |
| Present Solid | 26 | 44.02 | 43.48 |
| Solvent Cleaning | | 42.95 | |
| Composition | | | |
| Present Solid | 19 | 35.37 | 37.82 |
| Solvent Cleaning | | 40.27 | |
| Composition | | | |
| Water | n/a | 17.56 | 16.67 |
| | | 15.78 | |

The results in Table 8 show that the present solid cleaning composition produced superior removal of red food soil compared to a comparable liquid cleaning composition. A piece of delrin material was soiled with a red food soil including lard, corn oil, egg, and iron oxide. The soiled delrin material was contacted with the cleaning composition for 5 minutes, and the material was dipped in a water rinse. The weight of the soil on the material was determined before and after cleaning.

TABLE 8
Superior Removal of Red Food Soil by the Present
Solid Solvent Cleaning Composition.

| | Amount in | | Average |
|---|---|---|---|
| | Use Solution | % Soil | % Soil |
| | (gm/gal) | Removed | Removed |
| Comparable Liquid | 99 | 56.78 | 41.81 |
| Cleaning | | 26.85 | |
| Composition | | | |
| Present Solid | 26 | 70.46 | 68.39 |
| Solvent Cleaning | | 66.33 | |
| Composition | | | |
| Present Solid | 19 | 70.70 | 63.59 |
| Solvent Cleaning | | 56.49 | |
| Composition | | | |
| Water | n/a | 41.21 | 35.09 |
| | | 28.98 | |

26 g/gal solid has active ingredients at the same level as the 99 g/gal liquid. The results in Tables 7 and 8 demonstrate that the solids provided better soil removal than the liquid, even at a reduced (75%) level of actives.

The results in Table 9 show that the present solid cleaning composition produced superior foaming compared to a comparable liquid cleaning composition. This study employed a “FOAM IT” brand tank foamer set to produce slightly wet foam, 2 turns from the mid point. The foam was dispensed from use composition at 120° F. The foam was sprayed on a vertical stainless steel surface (approximately 15 ft by 15 ft) from a distance of about 10 ft. Two lots of the present solid composition were used. The results of Table 9 demonstrate that the present solids provided superior foaming (both better hang time and higher density) compared to the liquid. The liquid at 99 g/gal had a level of actives equal to the solid at 26 g/gal.

TABLE 9
Superior Foaming by the Present Solid Solvent Cleaning Composition.

| | Amount | | | % Foam | Rate of | |
|---|---|---|---|---|---|---|
| | in Use | Foam | | Remaining | Vertical | Initial |
| | Solution | Thickness | Foam Hang | 2 min After | Travel by | Appearance |
| | (gm/gal) | (in) | Time (sec) | Application | Foam | of Foam |
| Comparable | 99 | 0.5-1 | 26 | 25 | medium-fast | Thick wet foam |
| Liquid Cleaning | | | | | | with some |
| Composition | | | | | | large bubbles |
| | | | | | | entrapped. |
| Present Solid | 26 | 0.5-1 | 57 | 40 | medium | Foam appears |
| Solvent Cleaning | | | | | | thicker and |
| Composition | | | | | | denser than foam |
| | | | | | | from liquid |
| | | | | | | composition. |
| Present Solid | 19 | 0.5-1 | 41 | 25 | medium | Thick foam with |
| Solvent Cleaning | | | | | | large bubbles. |
| Composition | | | | | | |
| Present Solid | 26 | 0.5-1 | 54 | 30 | medium | Foam appears |
| Solvent Cleaning | | | | | | thicker and |
| Composition | | | | | | denser than |
| | | | | | | foam from liquid |
| | | | | | | composition. |
| Present Solid | 19 | 0.5-1 | 35 | 25 | medium | Thick foam with |
| Solvent Cleaning | | | | | | large bubbles. |
| Composition | | | | | | |

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. A solid solvent cleaning composition comprising:
about 10 to about 30 wt-% solvent;
about 10 to about 50 wt-% solidification agent; and
about 10 to about 70 wt-% cleaning agent;
the composition being a solid at room temperature.

2. The composition of claim 1, having a form of powder, flake, granule, pellet, tablet, lozenge, puck, briquette, brick, solid block, or unit dose.

3. The composition of claim 1, wherein the solvent comprises glycol ether.

4. The composition of claim 3, wherein the glycol ether comprises ethylene glycol ether, diethylene glycol ether, propylene glycol ether, dipropylene glycol ether, or mixture thereof.

5. The composition of claim 4, wherein the glycol ether comprises diethylene glycol monomethyl ether, dipropylene glycol methyl ether, dipropylene glycol normal propyl ether, or mixture thereof.

6. The composition of claim 5, comprising:
about 5 to about 10 wt-% diethylene glycol monomethyl ether;
about 5 to about 10 wt-% dipropylene glycol methyl ether; and
about 5 to about 10 wt-% dipropylene glycol normal propyl ether.

7. The composition of claim 1, wherein the solidification agent comprises polyethylene glycol that is solid at room temperature, EO/PO block copolymer that is solid at room temperature, amide that is solid at room temperature, water soluble starch that is solid at room temperature, water soluble cellulose that is solid at room temperature, poly(maleic anhydride/methyl vinyl ether), polymethacrylic acid, or mixture thereof.

8. The composition of claim 7, wherein the solidification agent comprises polyethylene glycol that is solid at room temperature.

9. The composition of claim 8, comprising about 15 to about 40 wt-% polyethylene glycol.

10. The composition of claim 8, wherein the polyethylene glycol comprises PEG 8000.

11. The composition of claim 10, comprising about 20 to about 35 wt-% PEG 8000.

12. The composition of claim 1, wherein the cleaning agent comprises surfactant, alkalinity source, sequestrant, or mixture thereof.

13. The composition of claim 12, wherein the cleaning agent comprises surfactant, alkalinity source, and sequestrant.

14. The composition of claim 12, wherein the surfactant comprises nonionic surfactant, anionic surfactant, or mixture thereof.

15. The composition of claim 14, wherein the surfactant comprises nonionic surfactant and anionic surfactant.

16. The composition of claim 14, comprising:
about 1 to about 30 wt-% nonionic surfactant;
about 1 to about 40 wt-% anionic surfactant; or mixture thereof.

17. The composition of claim 12, wherein the alkalinity source comprises alkali metal hydroxide, alkali metal silicate, or mixture thereof.

18. The composition of claim 17, wherein the alkalinity source comprises alkali metal hydroxide and alkali metal silicate.

19. The composition of claim 17, wherein the alkalinity source comprises sodium hydroxide, sodium metasilicate, or mixture thereof.

20. The composition of claim 19, comprising:
about 0.1 to about 15 wt-% sodium hydroxide;
about 1 to about 10 wt-% sodium metasilicate; or
mixture thereof

21. The composition of claim 12, wherein the sequestrant comprises aminocarboxylate, condensed phosphate, or mixture thereof.

22. The composition of claim 21, wherein the sequestrant comprises aminocarboxylate and condensed phosphate.

23. The composition of claim 21, comprising:
about 0.2 to about 10 wt-% aminocarboxylate;
about 5 to about 20 wt-% condensed phosphate; or
mixture thereof.

24. The composition of claim 1, comprising salt and further comprising complex of salt and cleaning agent, complex of solidification agent and salt, complex of solvent and salt, hydrates thereof, or combination thereof.

25. The composition of claim 24, comprising complex of salt and surfactant cleaning agent, or hydrate thereof.

25. The composition of claim 1, comprising solvent, solidification agent, and cleaning agent in amount effective to provide a solid cleaning composition with a melting point greater than 30° C.

26. The composition of claim 25, comprising solvent, solidification agent, and cleaning agent in amount effective to provide a solid cleaning composition with a melting point greater than 50° C.
